(19) United States
(12) Patent Application Publication
(10) Pub. No.: US 2006/0150032 A1
(43) Pub. Date: Jul. 6, 2006

(54) State management device, state management system, and job processing system

(76) Inventors: Kouji Furukawa, Ishikawa (JP); Kazuhiko Nakamura, Ishikawa (JP); Yasuhiko Handa, Ishikawa (JP); Naomi Yoshida, Ishikawa (JP); Jun Shinano, Ishikawa (JP); Jun Kaida, Ishikawa (JP)

Correspondence Address: THOMPSON HINE L.L.P., P.O. BOX 8801, DAYTON, OH, 45401-8801, US

(21) Appl. No.: 10/543,373

(22) PCT Filed: Jan. 27, 2004
(86) PCT No.: PCT/JP04/00683

§ 371 Date: Jul. 26, 2005

(30) Foreign Application Priority Data
Jan. 27, 2003 (JP) 2003-17163

(51) Int. Cl. G06F 11/00

(52) U.S. Cl. 714/47

(57) ABSTRACT

There are provided a state monitoring device and a state management system which monitor a use state of a PC by a user by utilizing detecting results of the human detection sensor effectively. The state monitoring device (10) for detecting whether a user is present at an operative position of PC (20), is connected to the PC (20) on a LAN (30). The information provided for the PC (20) by the state monitoring device (10), is shared with all the PCs (20) on the LAN (30).

### TECHNICAL FIELD

This invention relates to a state monitoring device for monitoring use state of a host device such as a personal computer. This invention also relates to a state management system and a job processing system each provided with the state monitoring device.

### BACKGROUND ART

Recently, many host devices such as personal computers are designed to operate in a power-saving operation mode. In the power-saving operation mode the host devices are held ready for restart with minimum power consumption. The host devices are normally shifted to the power-saving operation mode after a predetermined period of time during which the host devices neither receive a job command nor have an active job to be performed.

However it is preferable that the host devices shift to the power-saving operation mode depending on where their users are. When the user is away from the host device, immediate shift of the host device to the power-saving operation mode not only causes no inconveniences to the user, but also result in reduction of power consumption.

Japanese patent application laid-open No. 2000-195025 discloses a display device which is shifted to the power-saving operation mode when a user of the display is absent from an operative position of the display device. The display device detects the user's absence from the operative position automatically by means of a human detection sensor provided therein, and shifts to the power-saving operation mode immediately after the detection of the user's absence from the operative position. And it is said that the display device enables its power consumption to be reduced effectively.

However, the display device of the Japanese patent application laid-open No. 2001-195025 does not utilize detecting results of the human detection sensor most effectively. For example, the display device does not utilize the detecting result of the human detection sensor for managing use state of a host device or for setting an order of jobs of the host device. The detecting result of the human detection sensor would be usable for the host device to manage the use state and to set an order of jobs effectively.

Accordingly, it is an object of the invention to provide a state monitoring device and a state management system which manage a use state of a host device by a user, by utilizing detecting results of the human detection sensor effectively.

It is another object of the invention to provide a job processing system which performs a job by utilizing detecting results of the human detection sensor effectively.

### DISCLOSURE OF THE INVENTION

To solve the aforementioned problems, the present invention provides the following arrangements as itemized below.

(1) A state monitoring device connected to a host device and monitoring a use state of the host device by a user, including:

a detector for detecting presence of the user at an operative position where the user operates the host device; and

a notifier for notifying the host device, according to a detecting result of the detector, of the user's absence from the operative position or of the user's return to the operative position.

In this state monitoring device, the detector detects whether the user is present at the operative position or not. The notifier notifies the host device, according to the detecting result of the detector, that the user has left the operative position or that the user has returned to the operative position.

A personal computer (PC) is cited as a typical example of the host device. An infrared ray sensor or a temperature sensor is cited as a typical example of the detector.

Thus, the state monitoring device enables the host device to monitor use state thereof by the user appropriately.

Accordingly, the state monitoring device allows the host device to shift automatically to a power-saving operation mode as soon as the user leaves the operative position. The state monitoring device also allows the host device to manage information about use state of the host device by the user. Furthermore, if a host device connected to the state monitoring device is on a network, a use state of the host device can be monitored remotely.

(2) A state management system, including:

a plurality of host devices each connected to the state monitoring device of item (1); and

a network connected to the host devices;

wherein each one of the host devices sends information received from the state monitoring device, to the other host devices on the network.

In this state management system, one host device on the network provides the other host devices on the network with the information received from the state monitoring device. Thus all the host devices on the network share information about use state of all the host devices on the network.

(3) The state management system of item (2),

wherein each one of the host devices, according to the information received from the other host devices on the network, detects and displays use states of the other host devices on the network.

In this state management system, each one of the host devices on the network shows use states of the other host devices on the network to it's user.

Thus when a use state of any one of the other host devices on the network changes, the user recognizes the change through his or her host device's display.

Therefore, the user grasps whether or not users of the other host devices on the network are at the respective operative positions through his or her host device's display. The state management system enables any user of the host devices on the network to communicate with another user on the network who was absent from the operative position, as soon as the user returns to the operative position.

(4) The state management system of item (2),

wherein each one of the host devices is automatically disconnected from the network after a predetermined period of time during which the user of the host device is absent from the operative position.

This state management system cause a user of the system to log out from the system when a predetermined period of time has elapsed since the user left the operative position without logging out from the system.

Therefore, the system is protected against unauthorized access such as spoofing, thereby ensuring that security level of the system is improved.

(5) The state management system of item (2),

wherein each one of the host devices on the network keeps a chronological log of use state thereof.

In this state management system, the use state of each one of the host devices on the network is recorded in a log.

Thus presence/absence of all the users on the system can be checked through the log. Thus the log enable detection of the unauthorized use to become more easily. As a result, security level of the system using a computer network is improved.

(6) A job processing system including:

the state monitoring device of (1); and

a plurality of the host devices each connected to the state monitoring device;

wherein each one of the host devices has:
a job recorder for receiving and recording a job command input by a user for a job to be performed in a period of time during which the user is absent from the operative position; and
a job processor for performing the job recorded in the job recorder while the notifier is notifying the host device of the user's absence from the operative position.

In this construction, the job processing system includes the state monitoring device and the host devices. Each of the host devices performs the job recorded in the job recorder, when being notified by the state monitoring device that the user is absent from the operative position of the host device.

Generally, the job recorder records heavy-load jobs which are not required to be completed urgently (for example, making backup copy of files, writing files onto an optical medium such as a DVD, performing a virus scan on files, transferring large files).

The job recorder also records jobs inexecutable in a period of time during which files are updated (for example optimization of hard disk).

And it is effective to for the job recorder to register jobs which require the other processes on the host device to be halted (for example, updating of system or application programs).

This job processing system performs the heavy-load jobs as described above while the user is absent from the operative position, thereby preventing a decrease in performance of the host device when the user operates the host device.

(7) A job processing system including:

the state monitoring device of claim 1; and

a plurality of the host devices each connected to the state monitoring device;

wherein each one of the host devices makes a backup copy of data stored therein while the notifier is notifying the host device that the user has left the operative position.

In this job processing system, a backup of date stored in the host device is made when user's absence from the operative position is detected by the state monitoring device.

Therefore, the job processing system prevents a decrease in performance of the host device while the user is operating the host device.

The job processing system ensures frequent automatic data backup copy of data carefully, thereby preventing valuable data from being lost.

### BRIEF DESCRIPTION OF THE DRAWINGS

FIG. 1 illustrates a schematic configuration of a state management system of the invention;

FIG. 2 is a block diagram illustrating a schematic configuration of the state management system of the invention;

FIG. 3 illustrates a schematic configuration of an application program applied to a first embodiment;

FIGS. 4 (A) to 4 (C) illustrate examples of screens displaying use states of host devices;

FIG. 5 illustrates another configuration of the state management system of the invention;

FIG. 6 illustrates a schematic configuration of a job processing system of the invention;

FIG. 7 is a functional block diagram illustrating a configuration of the job processing system of the invention;

FIG. 8 illustrates a configuration of an application program applied to a second embodiment; and

FIG. 9 is a flowchart illustrating an operating sequence of PCs in the second embodiment.

### BEST MODE FOR CARRYING OUT THE INVENTION

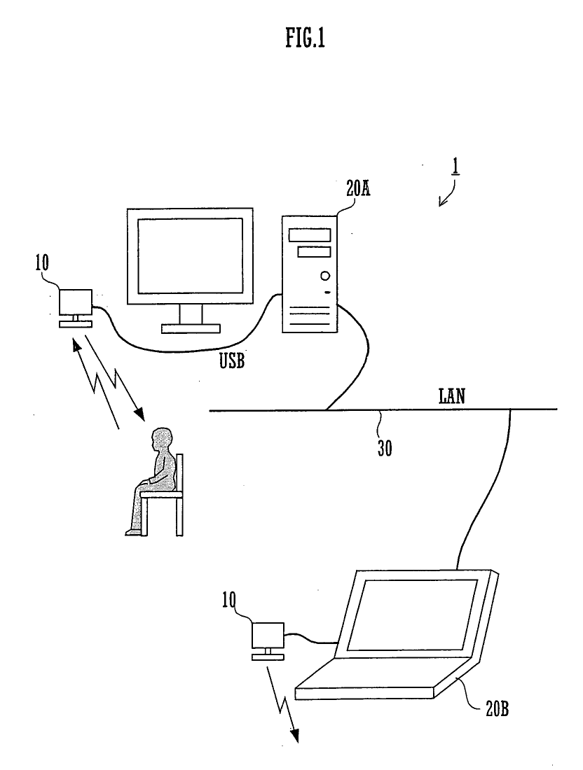

A state monitoring device, a state management system and a job processing system according to embodiments of the present invention are described below referring to the drawings. First, a state monitoring device and a state management system according to a first embodiment of the invention is described. FIG. 1 illustrates the schematic configuration of the state management system 1.

As shown in FIG. 1, the state management system 1 includes a Local Area Network (LAN) 30, a Personal Computer (PC)s 20A,20B, and state monitoring devices 10 respectively connected to the PCs 20A and 20B. The PCs 20A, 20B are the host devices of the invention.

On the PCs 20A and 20B, an application program to be described later is installed. Although the state management system 1 of the embodiment employs the two PCs 20A,20B, PCs to be connected to the LAN 30 are not limited to these two PCs. Any number of computers are usable in the state management system 1 as long as it has enough processing capability to run the application programs to be described later. The PCs 20A and 20B are connected to the state monitoring device 10 through a USB interface.

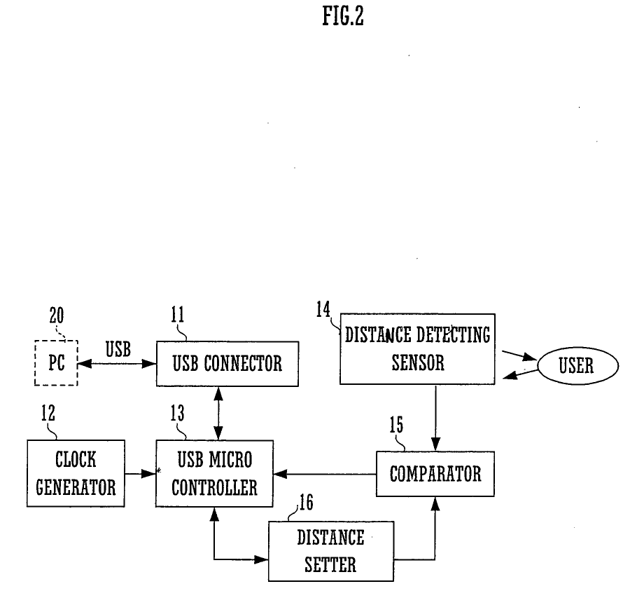

FIG. 2 is a block diagram illustrating the schematic configuration of the state monitoring device 10. A Power source supplying electricity to components of the state monitoring device 10 is not shown in FIG. 2.

The state monitoring device 10 has a USB connector 11, a clock generator 12, a USB micro controller 13, a distance detecting sensor 14, a comparator 15, and a distance setter 16. The USB connector 11 is connected to one end of a USB cable the other end of which is connected to the PC 20A or PC 20B. The USB connector 11 is also connected to a ground. The clock generator 12 generates a clock signal which is basic clock signal of state monitoring device 10, and output the clock signal to the USB micro controller 13. The distance detecting sensor 14 is an infrared ray sensor measuring a distance between the state monitoring device 10 and a user of the PC 20A or PC 20B.

Other types of sensors, such as a temperature sensor, may be used as the distance detecting sensor 14. The distance detecting sensor 14 outputs detected distance to the comparator 15.

The distance setter 16 sets a predetermined range of operative position of a host device of the invention. The operative position is a position where a user can operate the host device properly. The distance setter 16 sets the range of the operative position with reference to distance between the user and the distance detecting sensor 14.

In this embodiment, The operative position is set to be within a range of 0.3 m to 1.0 m from the distance detecting sensor 14. The distance setter 16 outputs the set value to the comparator 15.

The comparator 15 compares the detected distance result of the distance detecting sensor 14 with the set value of the distance setter 16. Then the comparator 15 outputs a comparison result to the USB micro controller 13. The comparison result indicates whether the detected distance of the distance detecting sensor 14 is larger or smaller than the set value of the distance setter 16. The USB micro controller 13 outputs to the PC 20A or PC 20B the comparison result received from the comparator 15. When the set value is modified by the PC 20A or PC 20B, the USB micro controller 13 provides the distance setter 16 with the modified set value received from the PC 20A or PC 20B. In this way, the USB micro controller 13 manages communications between the state monitoring device 10 and the PC 20A or PC 20B.

In the embodiment, the distance detecting sensor 14 constitutes the detector of the invention, and the USB micro controller 13 constitutes the notifier of the invention. The PCs 20A,20B detect whether a user is present at the operative position according to the comparison result received from the USB micro controller 13.

When the comparison result indicates that the detected distance of the distance detecting sensor 14 is larger than the set value of the distance setter 16, the USB micro controller 13 judges that a user is absent from the operative position. On the contrary, when the comparison result indicates that the detected distance is lower than the set value of the distance setter 16, the USB micro controller 13 judges that a user is present at the operative position.

Thus, the smaller the set value is set, the more likely it is that the user's absence from the operative position is detected. And the larger the set value is set, the less likely it is that the user's absence from the operative position is detected.

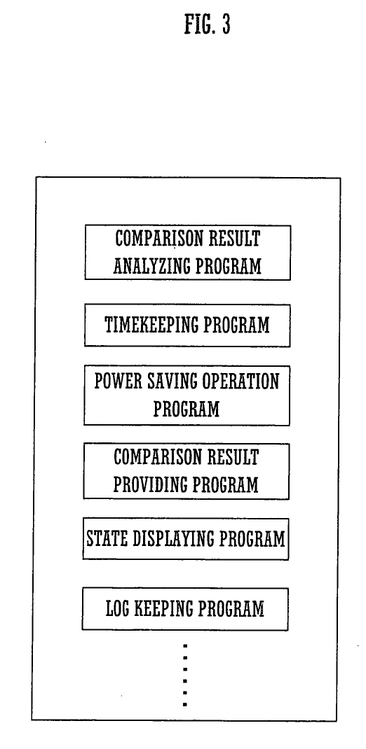

An application program installed on the PCs 20A and 20B (or merely the application program) is described below referring to FIG. 3.

The application program includes a comparison result analyzing program, a timekeeping program, a power saving operation program, a comparison result providing program, a state displaying program, and a log keeping program. The comparison result analyzing program causes a CPU of the PC 20A or 20B to perform the step of analyzing the comparison result provided by the USB micro controller 13. The timekeeping program causes the CPU to perform the step of measuring a period of time during which the user is absent from the operative position. The power saving operation program causes the CPU to perform the step of shifting the PC 20A or PC 20B to the power-saving operation mode after the predetermined period of time during which the user is absent from the operative position. The comparison result providing program causes the CPU to perform the step of sending information received from the USB micro controller 13, to the other PCs on the LAN 30 such as PC 20B. The state displaying program causes the CPU to display use state of the system 1 on the PC 20A or 20B's screen. The log keeping program causes the CPU of the PC 20A to keep a log of the use state of the system 1.

When a user of the PC 20A leaves the operative position, the state monitoring device 10 notifies the PC 20A that the user is absent from the operative position. Then PC 20A automatically shifts to the power-saving operation mode after the predetermined period of time during which the user is absent from the operative position.

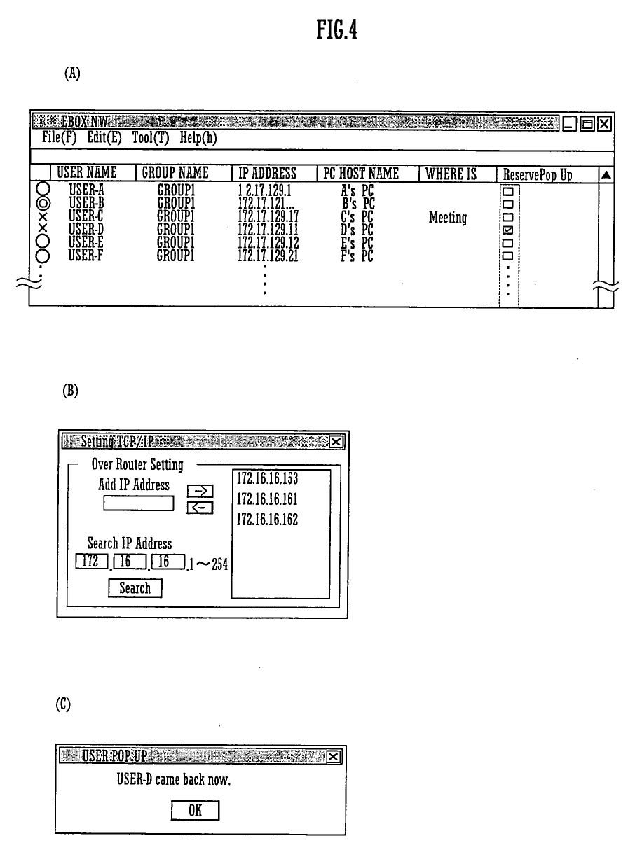

FIG. 4 illustrates an example of windows displayed on the PC 20A or 20B's screen. FIG. 4(A) illustrates a window indicating use state of a user of PCs on the LAN 30, displayed on the PC 20A or 20B's screen. FIG. 4(B) illustrates an example of windows for setting IP Address, displayed on the PC 20A or 20B's screen. FIG. 4(C) illustrates an example of message windows indicating a change in use state of any one of the PCs on the LAN 30.

It is troublesome for a user of one of the PCs on the LAN 30 to check the other users' presence with his or her eyes.

In the system 1 of the first embodiment, the application program installed on each one of the PCs on the LAN 30, allows any one of the PCs on the LAN 30 to display use state of the system 1.

For quick grasp of the users' presence at the respective operative positions, the window as shown in FIG. 4(A) includes fields for displaying use states, user names, network group names, IP addresses, PC's host names, user's present whereabouts, and check boxes, which are disposed in this order from left to right. If the check box is checked, change in state of corresponding user is notified.

In a field of use state, use states are indicated by a double circle, a circle, or a cross. The double circle means a user who operates a PC displaying the window. The circle means that corresponding user is present at the operative position. And the cross means that corresponding user is absent from the operative position. Marks for indicating use states are not limited to these three marks. The marks are selected freely according to graphical performance of the PCs 20.

Although the section of user's present whereabouts is not required for the embodiment, the section is provided, because information inputted into the section before leaving enables the other users to know where the user is. The check box is provided for a user of the system 1 who wants to grasp a change of use state of another PC.

If the check box is checked, change in use state of corresponding user is notified to a user who checked the box, as soon as the corresponding user leave or return to the operative position.

FIG. 4(C) shows an example of pop-up windows indicating change of use states. In FIG. 4(A), the check box corresponding to user D who is absent from the operative position is checked. Thus, the pop-up window is displayed on the user B's screen as soon as the user D returns to the operative position.

Means for notifying the user of a change of use state are not limited to the pop-up window, but may be an audio announcement.

In the state management system 1, the state monitoring devices 10 each connected to each one of the PCs 20 through the USB interface, detects user's presence and absence. Each one of the state monitoring devices 10 outputs the detecting result to each one of the PCs 20. The detecting result received from the state monitoring device 10 is shared among all the PCs 20 on the LAN 30.

Thus, the state management system 1 enables each one of the users of the system 1 to grasp the other users' condition through a window displayed on a monitor of each one of PCs 20.

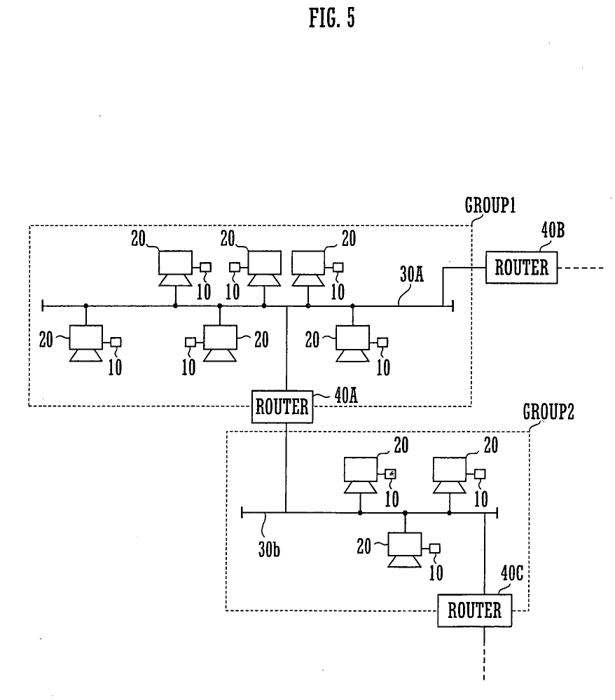

FIG. 5 illustrates another example of configuration of the state management systems of the invention. The network as shown in FIG. 5 is divided into a plurality of segments. Each segment constitutes LAN such as LAN (GROUP1) or LAN (GROUP2). The network also includes a plurality of routers such as routers 40A, 40B, and 40C.

The router 40A is disposed between LAN 30A and LAN 30B. In this construction, detecting result of a state monitoring device 10 connected to any one of PCs 20 on the LAN 30A, generally, is send only to the other PCs 20 on the LAN 30A. This is because it is easy for any one of the PCs 20 on the LAN 30A to get IP addresses of the other PCs 20 on the LAN 30A.

FIG. 4(B) shows an example of windows for manually setting IP address of PCs 20 on the LAN of different groups such as LAN 30B. This manual setting allows detecting result of a state monitoring device 10 connected to any one of PCs 20 on the LAN 30A, to be sent to PCs 20 on the LAN 30B. A user can select an automatic setting of IP address in which IP addresses of PCs 20 on another network are detected automatically.

E-mail may be used as means for communicating information about use state of PCs with PCs on another LAN. In this case, e-mail addresses of receivers are preliminarily stored in the PCs 20. Then each one of the PCs 20 sends e-mails including information about use state, to the e-mail address stored therein, regardless of groups of the receivers. Because use state of PCs on the network is grasped through a screen of each one of the PC on the network, miscommunication among users on the network is not likely to happen.

The PC 20 keeps log files by recording information about detecting result of the distance detecting sensor 14. The log files enable checking of length of period of time during which a user is absent from the operative position. The log files also enables checking whether anyone operates the PCs on the network at an irregular time.

In the light of security of the system 1, it is effective that each one of the host devices is disconnected from the network automatically, as soon as the users leave the operative position, or, after a predetermined period of time during which the user is absent from the operative position.

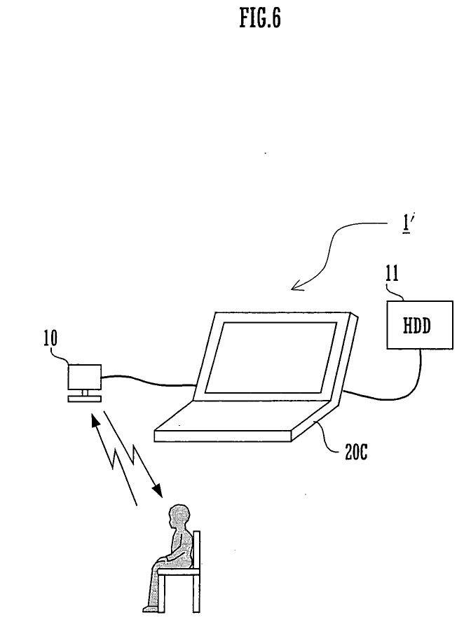

A state monitoring device, and a job processing system according to a second embodiment of the invention are described below. FIG. 6 shows a configuration of a job processing system of the invention.

The job processing system 1′ includes at least one PC 20C, a state monitoring device 10 connected to the PC 20C, and a storage device.

In this embodiment, an external hard disk 11 is used as the storage device connected to the PC 20C. A configuration of the state monitoring device 10 is essentially same as the configuration of the state monitoring device of the first embodiment.

In addition, the hard disk 11 is not limited to an external hard disk, but may be an internal hard disk.

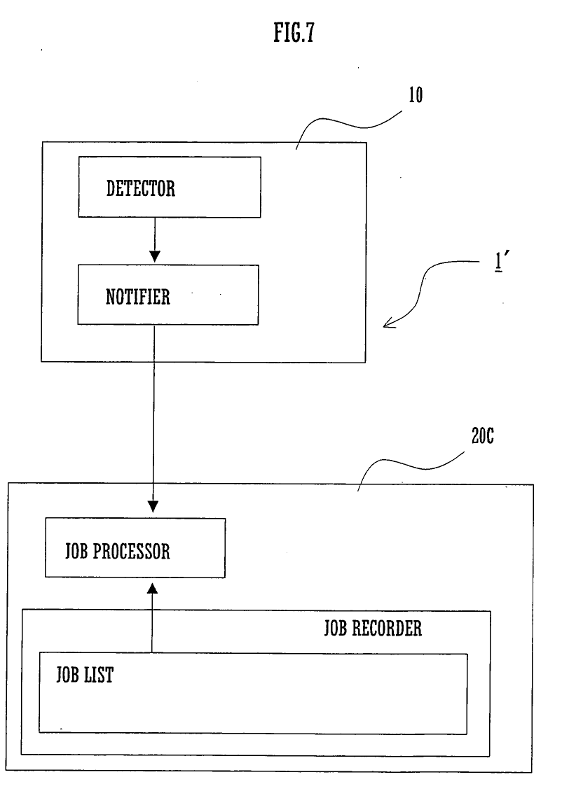

FIG. 7 is a functional block diagram of a job processing system 1′ of the invention. In the job processing, the state monitoring device 10 has a detector for detecting whether the user is present at an operative position of the PC 20C.

The state monitoring device 10 also includes a notifier for providing the PC 20C with information on whether the user is detected at the operative position by the detector, based on a detecting result of the detector.

The information is utilized effectively by the job processor provided on the PC 20C. More specifically, the job processor recognizes a period of time during which the user is absent from the operative position, by means of the information received from the notifier.

In the period of time the job processor performs jobs recorded on a job list of a job register which is also provided on the PC 20C.

The job list includes information about jobs which should be executed while the user is absent from the operative position. Registration of a job on the job list is performed by application programs installed on the PC 20C. In this embodiment, users can select jobs to be put into the job list.

For example, jobs such as making a backup of files, writing files onto an optical disk, or performing a virus scan on files, are registered on the job list. It is effective to set an order of priority of the jobs on the list, because the order of priority allow the PC 20C to perform high-priority jobs ahead of the other jobs while the user is absent from the operative position.

It is also effective to record estimated time required for each one of the jobs so that the PC 20C can select jobs to be performed according to the estimated time.

It is preferable to set how long the user will be absent from the operative position before the user leaves the operative position so that the PC 20C to can more precisely select jobs to be performed.

A job of making a backup of files is a representative example of a job registered on the job list. So the case where job of making a backup copy of files are registered on the job list is described in the embodiment.

In the embodiment, a distance detecting sensor 14 is employed as the detector, and a USB micro controller 13 is employed as the notifier.

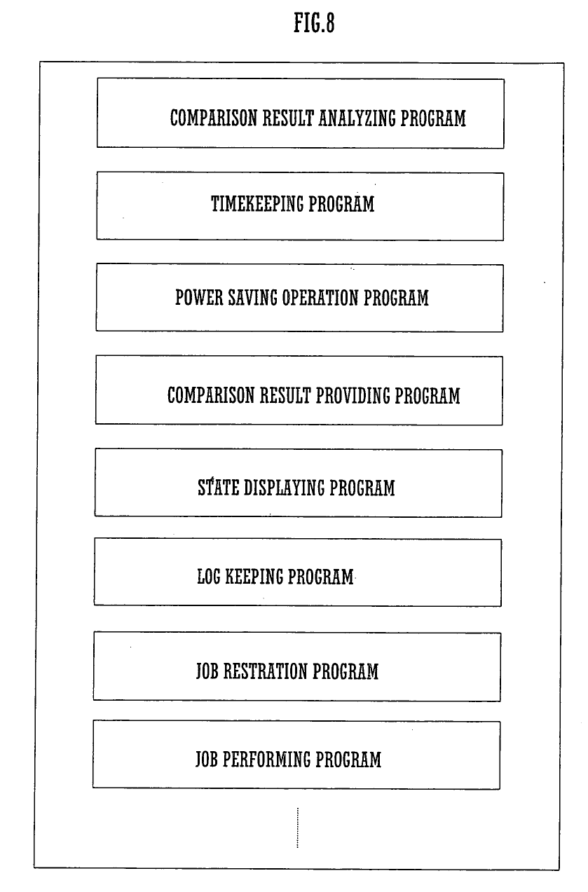

In the embodiment, an application program installed on the PC 20C constitutes the job register and the job processor. FIG. 8 shows a configuration of an application program of a second embodiment.

A basic configuration of the application program of the second embodiment is similar to that of the application program of the first embodiment.

The application program of the second embodiment further includes a job registration program and a job performing program.

The job registration program causes the CPU of the PC 20C to perform the steps of receiving a job command input by a user and of putting the received job command into the job list.

More specifically, the job registration program causes the PC 20C to display a window for inputting job information, and put the job information inputted through an inputting section such as a keyboard, into the job list.

The job list is stored in a predetermined area in a memory on the PC 20C.

The job processing program causes the CPU to perform the step of performing the job recorded on the job list in a period of time during which the user of the PC 20C is absent from the operative position.

In the embodiment, the job processing program includes a backup processing program.

The backup processing program causes the CPU to perform the step of making a backup of files selected by the user on the hard disk 11, after a period of time during which the user is absent from the operative position.

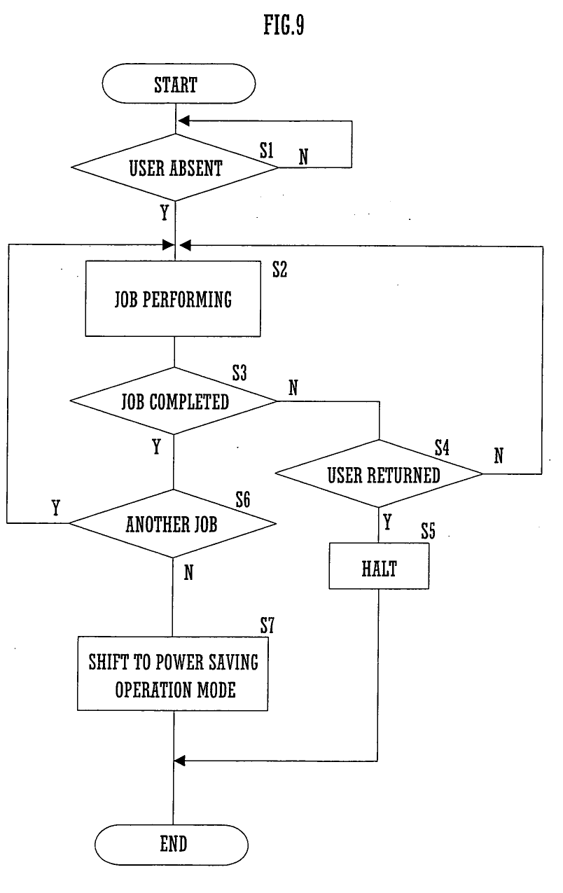

FIG. 9 is a flowchart showing an operating sequence of CPU of the PC 20C (or merely the CPU) of the second embodiment. A backup processing is described as an example of job processing.

The CPU waits until the user's absence from the operative position of the PC 20C is detected (S1).

When the user's absence is detected in the wait step of S1, the CPU reads the backup processing program and starts the backup processing (S2).

Files to be backed up are preliminarily selected by the user.

Either a differential backup processing or a full backup processing can be applied to the backup processing of step S2. In the differential backup processing, copies of all files modified since a preceding full backup are made. In the full backup processing, copies of all the files are made.

The user can specify which of the differential and full backup processing is to be performed. In the backup processing, a backup of the files is made on the hard disk 11. A destination of the backup to save is not limited to the hard disk 11, but may be a removable disk.

Then, the CPU waits until the backup processing is completed (S3). If the backup processing is completed in the step of S3, then the CPU judges whether another job to be executed remains or not (S6).

More specifically, the CPU checks on the job list. If there is no job remaining on the job list in the step of S6, the CPU shifts the PC 20C to the power saving operation mode (S7), and waits for another job command.

If there is another job to be processed on the job list, the CPU performs the job.

If the backup processing is not completed in the waiting step of S3, the CPU judges whether the user has returned to the operative position (S4).

If the user has returned to the operative position in step of S4, the CPU stops performing the backup processing (S5).

In the embodiment the backup processing is stopped in the step of S5. Alternatively, the backup processing may be continued, or another processing such as conforming a history of the backup processing may be performed in the step of S5. The CPU waits for another job command after completion of the step of S5.

While the invention has thus far been described with reference to the preferred embodiment thereof, the aforementioned arrangement of the embodiment should be construed as being simply illustrative and not limiting the invention. The scope of the invention is shown solely by the appended claims, and not by the foregoing embodiment. It is to be understood that the invention is intended to cover the appended claims as well as all possible modifications of the embodiment and equivalents thereof which may occur to those skilled in the art within the spirit and scope of the invention.

1-5. (canceled)

6. A job processing system comprising:
a state monitoring device connected to a host device and monitoring a use state of the host device by a user, the state monitoring device having a detector for detecting presence of the user at an operative position where the user operates the host device, and a notifier for notifying the host device, according to a detecting result of the detector, of the user's absence from the operative position or of the user's return to the operative position; and
a plurality of the host devices each connected to the state monitoring device;
wherein each one of the host devices has:
a job recorder for receiving and recording a job command input by a user for a file to be duplicated in a period of time during which the user is absent from the operative position; and
a job processor for making a backup of the file recorded in the job recorder while the notifier is notifying the host device of the user's absence from the operative position.

7. A The job processing system of claim 6, further comprising an external storage device connected to the host device, wherein the job processor makes a backup of the file recorded in the job recorder on the external storage device.

8. The job processing system of claim 7,
wherein the job processor shifts the host device to power saving operation mode, if there is no job recorded in the job recorder while the notifier is notifying the host device of the user's absence from the operative position.
